(19) United States
(12) Patent Application Publication
(10) Pub. No.: US 2023/0202334 A1
(43) Pub. Date: Jun. 29, 2023

(54) POWER MODULES, SYSTEMS, AND METHODS FOR ALLOCATING ELECTRICAL POWER TO MULTIPLE VEHICLES

(71) Applicant: Rivian IP Holdings, LLC, Plymouth, MI (US)

(72) Inventors: Deidre Yiu, San Francisco, CA (US); Khaled Bahei-Eldin, Irvine, CA (US)

(21) Appl. No.: 17/564,861

(22) Filed: Dec. 29, 2021

(51) Int. Cl. B60L 53/66; G05B 15/02; H02J 7/00

(52) U.S. Cl. CPC B60L 53/66; G05B 15/02; H02J 7/0013

(57) ABSTRACT

Various disclosed embodiments include illustrative direct current (DC) power electronics modules, charging systems, and methods. In an illustrative embodiment, a DC power electronics module includes an electronics component configured to provide DC power to at least a first battery and a second battery, a processor configured to communicate with the electronics component, and non-transitory computer-readable media configured to store computer-executable instructions. The stored instructions cause the processor to determine connection status of the first battery and the second battery to the DC power electronics module and instruct the electronics component and/or a connection device to allocate DC power to the first battery and the second battery responsive to the determination that the first battery and the second battery are connected to the DC power electronics module.

### INTRODUCTION

The present disclosure relates to electric charging systems, such as those for vehicles, buildings, and/or homes, among other possibilities. The statements in this section merely provide background information related to the present disclosure and may not constitute prior art.

Electric chargers, such as electric vehicle (EV) chargers and energy storage chargers for buildings and/or homes, may include alternating current (AC) chargers, which use inverters on board the vehicle, and direct current (DC) chargers. Users of EV chargers with more than one EV and/or energy storage system may have to purchase additional AC chargers or DC chargers and attend to associated installation costs.

### BRIEF SUMMARY

Various disclosed embodiments include illustrative DC electrical power electronics modules, charging systems, and methods.

In an illustrative embodiment, a power electronics module is configured to provide DC power to one or more of a first battery and a second battery, a processor configured to communicate with power electronics module, and non-transitory computer-readable media configured to store computer-executable instructions. The stored instructions cause the processor to determine one or more connections with the first battery and/or the second battery to the power electronics module and allocate electrical power to one or more of the first battery and the second battery responsive to the determination that one or more of the first battery and the second battery are connected to the electrical power electronics module, where the electrical power includes one or more of DC power or AC electrical power.

In an illustrative embodiment, a DC power electronics module includes an electronics component configured to provide DC power to at least a first battery and a second battery, a processor configured to communicate with the electronics component, and non-transitory computer-readable media configured to store computer-executable instructions. The stored instructions cause the processor to determine connection status of the first battery and the second battery to the DC power electronics module and instruct the electronics component and/or a connection device to allocate DC power to one or more the first battery and the second battery responsive to the determination that the first battery and the second battery are connected to the DC power electronics module. The DC power may be allocated to the first battery without allocation to the second battery, and further, the DC electrical power may be allocated to the second battery without allocation to the first battery as well.

In another illustrative embodiment, a charging system includes a connection device couplable to a first battery and a second battery, and a DC power electronics module. The DC power electronics module includes an electronics component configured to provide DC power to the first battery and the second battery via the connection device. Also, the DC power electronics module includes a processor configured to communicate with the electronics component and non-transitory computer-readable media configured to store computer-executable instructions configured to cause the processor to determine connection status of the first battery and the second battery to the connection device and instruct the electronics component and/or the connection device to allocate DC power to the first battery and the second battery responsive to the determination that the first battery and the second battery are connected to the connection device.

In another illustrative embodiment, a method includes detecting battery connections to a DC power electronics module and responsive to detecting a first battery and a second battery being connected to the DC power electronics module, allocating DC power to the first battery and the second battery.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a schematic diagram of a vehicle charging environment.

FIG. 2A is a block diagram of a first connection configuration used in the vehicle charging environment of FIG. 1.

FIG. 2B is a block diagram of a second connection configuration used in the vehicle charging environment of FIG. 1.

FIG. 2C is a block diagram in partial schematic form of details of the second connection configuration of FIG. 2B.

FIG. 3 is a block diagram of a component of a charging system included in the vehicle charging environment of FIG. 1.

FIG. 4 is a flow diagram of an illustrative method performed by the system of FIGS. 1-3.

FIG. 5 is flow diagram of an illustrative method performed by the system of FIGS. 1-3.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative power electronics modules, charging systems, and methods. As will be explained below, such embodiments can control allocation of DC electrical power to multiple vehicles.

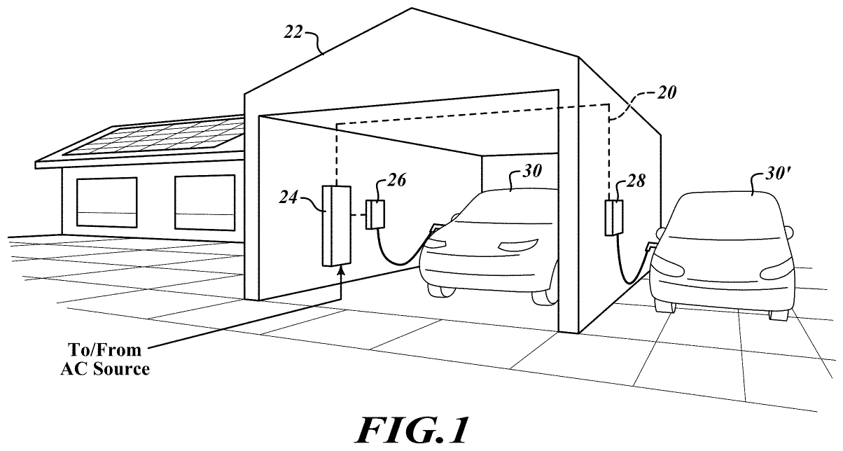

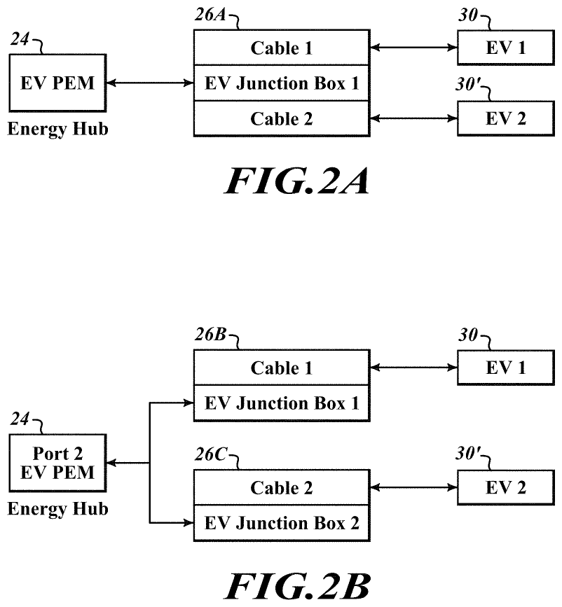

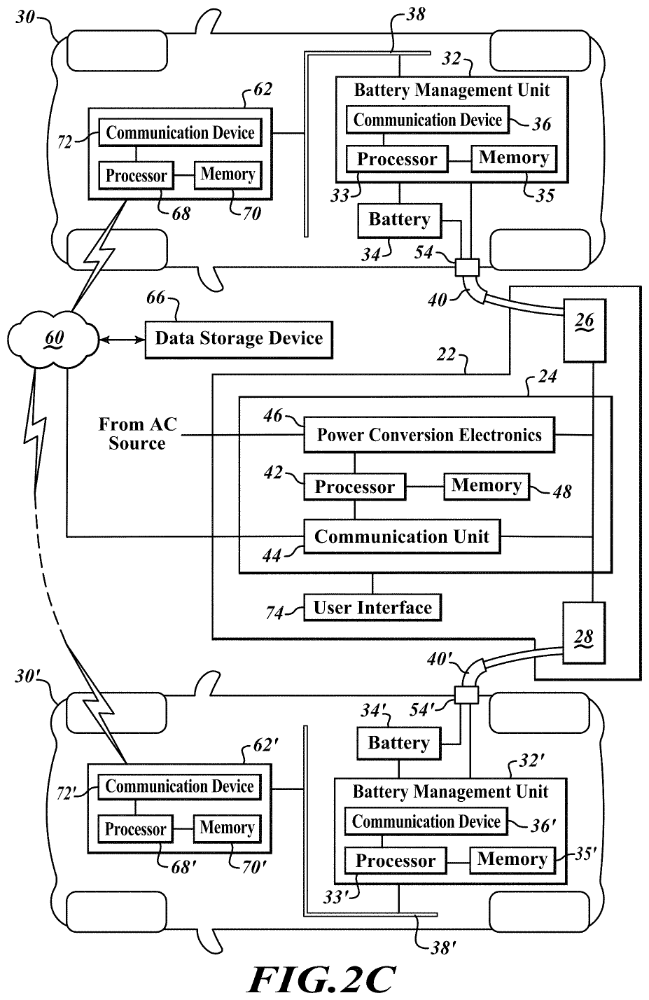

Given by way of non-limiting overview and referring to FIGS. 1 and 2A-C, in various embodiments an illustrative charging system 20 includes a connection device (such as a charging unit 26) couplable to a first battery 34 and a second battery 34′ and a DC electrical power electronics module (PEM) 24. The PEM 24 includes an electronics component (such as power conversion electronics 46) configured to provide DC electrical power to the first battery 34 and the second battery 34′ via the charging unit 26. Also, the PEM 24 includes a processor 42 configured to communicate with the electronics component (power conversion electronics 46) and non-transitory computer-readable media (such as memory 48) configured to store computer-executable instructions configured to cause the processor 42 to determine connection status of the first battery 34 and the second battery 34′ to the charging unit 26 and instruct the power conversion electronics 46 and/or the charging unit 26 to allocate DC electrical power to the first battery 34 and the second battery 34′ responsive to the determination that the first battery 34 and the second battery 34′ are connected to a second charging unit 28.

Now that an overview has been presented by way of illustration only and not of limitation, details will be set forth by way of non-limiting examples given by way of illustration only and not of limitation.

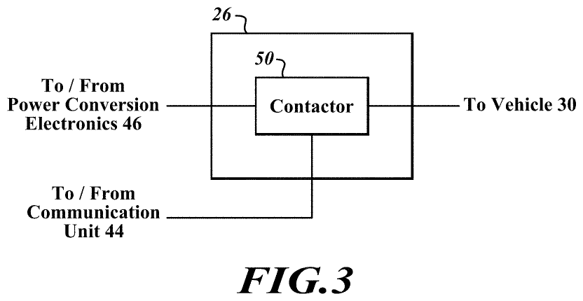

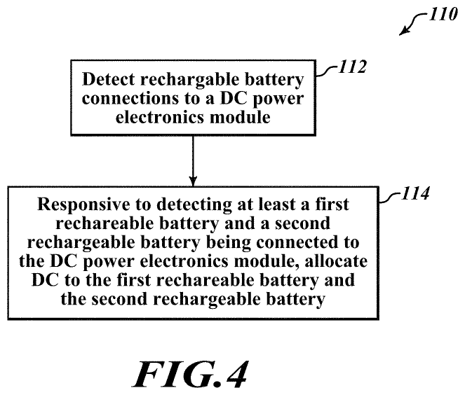

As shown in FIGS. 1 and 2, in various embodiments the illustrative charging system 20 is configured to allocate DC electrical power from a single PEM (the PEM 24) to the multiple batteries 34 and 34′ located in different vehicles 30 and 30′. In various embodiments the system 20 may be included in a structure 22. The structure 22 may be a house or any other structure capable of connecting to an AC grid energy source or other external energy supply/source. The system 20 includes the PEM 24 and the charging units 26 and 28 electrically coupled to the PEM 24. The first charging unit 26 includes a charging cord 50 capable to electrically connect to the first battery 34 via a charging port 54 of the first vehicle 30. The second charging unit 28 includes a charging cord 50′ capable to electrically connect to the second battery 34′ via a charging port 54′ of the second vehicle 30′. In various embodiments the charging units 26 and 28 may be replaced by a single charging unit as described by an optional configuration of FIGS. 3 and 4.

Referring additionally to FIG. 2, in various embodiments the PEM 24 includes the power conversion electronics 46, a communication unit 44, the processor 42, and the non-transitory computer-readable media (the memory 48) that stores computer-executable instructions that cause the processor 42 to receive information from the vehicles 30 and 30′, send information/instructions to the charging units 26 and 28, and perform various functions as described herein.

In various embodiments and given by way of overview, the illustrative vehicles 30 and 30′ each include a battery management unit (BMU) 32 and 32′, the battery 34 and 34′, a control unit 62 and 62′, and the charging port 54 and 54′. In various embodiments the BMUs 32 and 32′ and the control units 62 and 62′ may communicate with each other and with numerous other vehicle components via respective networks 38 and 38′, such as a network bus like a peer-to-peer network bus, such as a controller area network (CAN) bus. Other network buses, such as a local area network (LAN), a wide area network (WAN), or a value-added network (VAN), may also be used for enabling communication between the components connected to the networks 38 and 38′.

In various embodiments the control units 62 and 62′ each include a processor 68 and 68′, non-transitory computer-readable media (memory 70 and 70′), and a communication device 72 and 72′. The memory 70 and 70′ includes instructions configured to cause the processor 68 and 68′ to store and transmit operational information of the vehicles 30 and 30′ to the PEM 24 via a data network 60 and/or the communication unit 44. The data network 60 is configured to allow communications between the vehicles 30 and 30′, and a data storage/analysis device 66 that is also accessible by the communication unit 44 of the PEM 24. The data network 60 may be a public or private data network, such as, without limitation, a cellular network, a local area network (LAN), a wide area network (WAN), or the like. The data storage/analysis device 66 receives the operational information of the vehicles 30 and 30′. The data storage/analysis device 66 may include a processor configured to execute instructions stored in non-transitory computer-readable media for analyzing the received operational information and providing priority charging information to the PEM 24 via the communication unit 44 and the network 60 responsive to the analyzed operational information.

In various embodiments the operational information may include user information, time, the day of the week, travel location information, or the like. The travel location information may include destination, battery recharging information, or other comparable information.

In various embodiments the BMUs 32 and 32′ each include a processor 33 and 33′, communication devices 36 and 36′, and non-transitory computer-readable media (memory 35 and 35′). The memories 35 and 35′ store computer-executable instructions configured to cause the processors 33 and 33′ to perform various battery management functions such as, without limitation, assessing battery temperature and state of charge, or other battery information. The communication devices 36 and 36′ may send the assessed battery information to the PEM 24 via the charging ports 54 and 54′, the power cords 40 and 40′, and the respective charging units 26 and 28. Charging information produced by the PEM 24 may be sent back to the respective BMUs 32 and 32′ via the charging ports 54 and 54′, the power cords 40 and 40′, and the respective charging units 26 and 28.

In various embodiments user may input charging preference information via a user interface device 74 couplable to the PEM 24, the vehicles 30 and 30′, and/or the data storage/analysis device 66 via the network 60. The charging preference information may be used by the data storage/analysis device 66, or the processors 33, 33′, 42, 68, or 68′ to generate allocation instructions. The user interface device 74 may be a personal electronics device, a keypad, touch display, a voice recognition device, or other comparable device for entering information.

Referring additionally to FIG. 3, in various embodiments the first charging unit 26 (and similarly the second charging unit 28) include a controllable contactor 50. The controllable contactor 50 includes a controllable switch connected between the power conversion electronics 46 and the battery 34. The controllable contactor 50 may receive instructions from the processor 42 via the communication unit 44 instructing the controllable contactor 50 to either deactivate or activate. Alternatively, the charging units 26 and 28 may be replaced by a single connection device (connection device 26A, FIG. 2A) having multiple controllable contactors coupled to respective charging cords (cable 1, cable 2) or a single contactor that may include multiple controllable switches coupled in the same manner as the controllable contactor 50 described above. Controllable contactors are extremely well known in the art and no further explanation is necessary for a person of ordinary skill in the art to understand disclosed subject matter. Those skilled in the art will recognize that the charging units 26 and 28 may include any suitable electrical charger, charging device, or charging system, such as, without limitation, a DC fast charging device, or other Electric Vehicle Supply Equipment (EVSE), as desired for a particular application.

In various embodiments the instructions stored in the memory 48 are further configured to cause the processor 42 to determine connection status of the first battery 34 and the second battery 34′ to the power conversion electronics 46 and instruct the power conversion electronics 46 to sequentially allocate DC electrical power to the first battery 34 and the second battery 34′. For example, the power conversion electronics 46 may sequentially allocate DC electrical power by sending DC electrical power to the first battery 34 for a first period of time and then sending DC electrical power to the second battery 34′ for a second period of time, where the first period of time occurs before the second period of time. The power conversion electronics 46 may analyze other factors, as will be described below, for determining how to allocate the DC electrical power. In another example, the power conversion electronics 46 may continue charging the first battery 34 and when complete the power conversion electronics 46 begins charging the second battery 34′.

In various embodiments the instructions are further configured to cause the processor 42 to instruct the power conversion electronics 46 and/or the charging units 26 and 28 to allocate DC electrical power to the first battery 34 and the second battery 34′ responsive to a determined or a previously defined charging time interval.

In various embodiments the instructions are further configured to cause the processor 42 to receive via the communication unit 44, first use history information of a first device (the first vehicle 30) associated with the first battery 34 and second use history information of a second device (the second vehicle 30′) associated with the second battery 34′ and instruct the power conversion electronics 46 and/or the charging units 26 and 28 to allocate DC electrical power responsive to the received first use history information and the received second use history information.

In various embodiments the first use history information is received from the first vehicle 30 and the second use history information is received from the second vehicle 30′. The use history information may also be sent to a network accessible device (the data storage/analysis device 66) via the network 60 for storage and/or analysis.

In various embodiments the first use history information and the second use history information may include information chosen from date of use information, time of use information, user who was operating the vehicle during those times and dates of use, and other information related to how the vehicle was used, such as travel, destination information, charging information.

In various embodiments the instructions produced by the processor 42 may include directions to turn on and off the controllable contactors 50 and 50′ at particular intervals, such as, without limitations, 15-minute charging intervals performed during a particular charging window of time (9 p.m. to 6 a.m.). In one non-limiting scenario, the charging intervals and when charging is to occur may be dependent upon the information received from the vehicles 30 and 30′ and an analysis of the received information. It may be determined that the first vehicle 30 typically leaves the structure 22 at 5 a.m. and travels on Mondays-Fridays 40 miles to a charging facility (work for a first user). The information related to the second vehicle 30′ indicates no weekday travel until 11 a.m. As such, the processor 42 may determine to give the first vehicle more time charging due to the above scenario.

In another non-limiting scenario, the received information is the same as that above, however, the information includes some anomalous, random trips by one of the vehicles. The processor 42 may assess that these anomalous, random trips don't fit any regular pattern (outside of a threshold value) and may not be considered (filtered out) when determining the instructions for allocation of charging the vehicles 30 and 30′.

In various embodiments and given by way of example only and not of limitation, the batteries 34 and 34′ suitably include high energy rechargeable batteries that store electrical charge, discharge electrical current upon request, and recharge. The rechargeable batteries may be structured in any desirable form, such as, without limitation, cylindrical, pouch, prismatic, massless, or other comparable forms. In various embodiments the rechargeable batteries may include Iron-air batteries, Li-ion batteries, such as without limitation, Nickel Cobalt Aluminium, Lithium Manganese Cobalt, or Lithium Manganese Oxide batteries. However, other materials may be used that provide comparable recharging, energy density, and energy discharge capabilities.

In various embodiments the communication devices 36 and 36′ may include any suitable wired or wireless device (such as a transceiver or the like) configured to communicate with the communication unit 44 using various network access devices, methods, and/or protocols, such as, without limitation, a wireless (WiFi, Bluetooth, or the like) connection with a network portal/modem/router, a wired or wireless connection, or the like.

In various embodiments the charging ports 54 and 54′ include DC power and communication leads that allow for the transmission of instructions between the processors 33 and 33′ and the communication unit 44 in accordance with a communication protocol, such as, without limitation, the Combined Charging System (CCS) protocol, the CHAdeMO protocol, or other charger protocols.

In various embodiments the grid AC supply may provide electrical power from a variety of different devices, such as wind turbine, solar cell, geothermal, nuclear power plants, hydro-electric power plants, natural gas power plants, coal-run power plants, or any mechanism that can produce AC electrical power.

Given by way of non-limiting example, in various embodiments the vehicles 30 and 30′ may be an electric vehicle (that is, an all-electrically driven vehicle) or a hybrid vehicle. For example and given by way of non-limiting examples, in various embodiments the vehicle may include a motor vehicle driven by wheels and/or tracks, such as, without limitation, an automobile, a truck, a sport utility vehicle (SUV), a van, an all-terrain vehicle (ATV), a motorcycle, an electric bicycle, a tractor, a lawn mower, such as, without limitation a riding lawn mower, a snowmobile, and the like. Given by way of further non-limiting examples, in various embodiments the vehicles 30 and 30′ may include a marine vessel such as, without limitation, a boat, a ship, a submarine, a submersible, an autonomous underwater vehicle (AUV), and the like. Given by way of further non-limiting examples, in various embodiments the vehicles 30 and 30′ may include an aircraft such as, without limitation, a fixed wing aircraft, a rotary wing aircraft, and a lighter-than-air (LTA) craft.

In various embodiments and given by way of example only and not of limitation, the power conversion electronics 46 may include an AC-DC bidirectional inverter device and multiple DC-DC converters that are configured according to the device they are to be connected to. The AC-DC bidirectional inverter device converts AC received from the AC electrical power source to DC and converts DC received from a DC energy storage device and/or the batteries 34 and 34′ back to AC. Bidirectional inverters and DC-DC converters are extremely well known in the art and no further explanation is necessary for a person of skill in the art to understand disclosed subject matter.

As discussed herein, in various embodiments the memory 35, 35′, and 48 include non-transitory computer-readable storage medium that include computer-readable code (instructions) stored thereon for causing the respective processors 33, 33′, and 42 to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include the instructions executable by the respective processors 33, 33′, and 42 that, in response to such execution, causes performance of a set of operations, steps, methods, processes, algorithms, functions, techniques, etc. as described herein for the various embodiments.

Referring additionally to FIG. 4, in various embodiments an illustrative action diagram 110 is provided for by a control unit executing instructions stored in a memory. At a block 112, battery connections to a DC electrical power electronics module are detected. At a block 114, responsive to detecting a first battery and a second battery being connected to the DC electrical power electronics module, DC electrical power is allocated to the first battery and the second battery.

In some embodiments allocating DC electrical power further includes instructing the electronics component to sequentially allocate DC electrical power to the first battery and the second battery.

In some embodiments, instructing the electronics component to allocate DC electrical power further includes instructing the electronics component to allocate DC electrical power to the first battery and the second battery at a previously defined time interval.

In some embodiments first use history information is received from the first device and second use history information is received from the second device. The electronics component is further instructed to allocate DC electrical power responsive to the received first use history information and the received second use history information.

In some embodiments the first use history information and the second use history information include information selected from date of use information and time of use information.

In some embodiments, the first use history information and the second use history information include travel information.

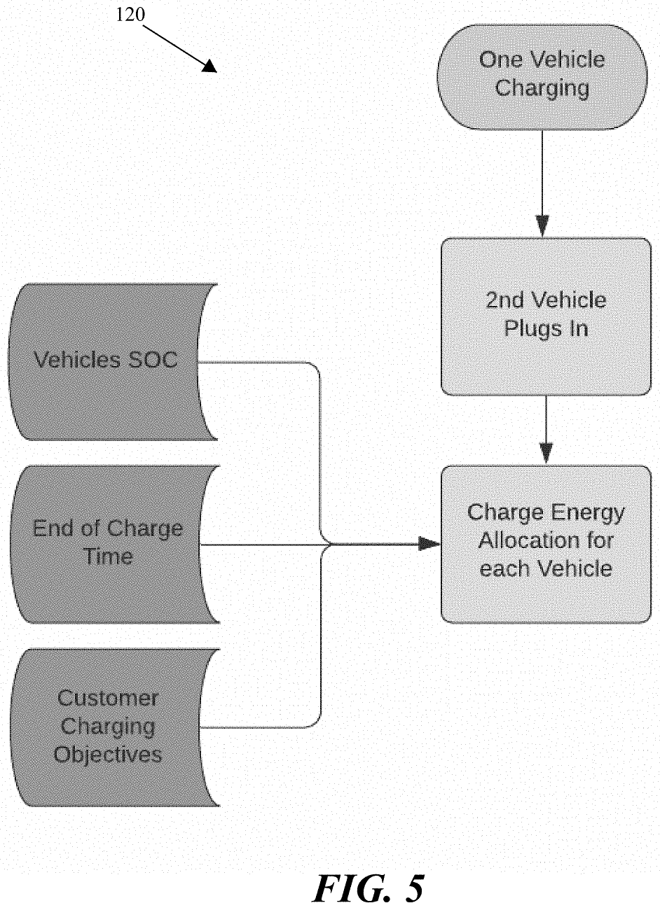

Referring additionally to FIG. 5, in various embodiments an illustrative action diagram 110 is provided for by a control unit executing instructions stored in a memory. Once a second vehicle plugs into the same charging system that a first vehicle is plugged into. Various information from both vehicles is received and analyzed to determine how to allocate electrical power to the vehicles. The information includes the state of charge of the batteries for each of the vehicles. For example, the battery of the first vehicle may have a 50% charge and the battery of the first vehicle may have only a 20% charge. The information may also include an end of charge time. The end of charge time may relate to when charging may be complete for the vehicle or may be a value set by a user. The information may also include customer charging objectives. The customer charging objectives may be set by a user or determined according to vehicle use information, such as the vehicle leaves house at 5 a.m. every Monday thru Friday. In various scenarios, the vehicle with a lower state of charge that leaves the charging system early in the morning may be given higher charging priority and thus may be allocated electrical power first.

As discussed herein, in various embodiments the processors 33, 33′, and 42 and the data storage/analysis device 66 suitably may include computer processors, data processors, or the like, that are configured to execute instructions received from external sources or stored in local memory 35 and 48. Those skilled in the art will recognize that at least a portion of the controllers, devices, units, and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

The term controller, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of controller (e.g., at a first time), as a second type of controller (e.g., at a second time, which may in some instances coincide with, overlap, or follow a first time), and/or as a third type of controller (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first controller that has a first purpose, then a second controller that has a second purpose and then, a third controller that has a third purpose, and so on. The transition of a reconfigurable and/or controllable component may occur in as little as a few nanoseconds, or may occur over a period of minutes, hours, or days.

In some such examples, at the time the controller is configured to carry out the second purpose, the controller may no longer be capable of carrying out that first purpose until it is reconfigured. A controller may switch between configurations as different components/modules in as little as a few nanoseconds. A controller may reconfigure on-the-fly, e.g., the reconfiguration of a controller from a first controller into a second controller may occur just as the second controller is needed. A controller may reconfigure in stages, e.g., portions of a first controller that are no longer needed may reconfigure into the second controller even before the first controller has finished its operation. Such reconfigurations may occur automatically, or may occur through prompting by an external source, whether that source is another component, an instruction, a signal, a condition, an external stimulus, or similar.

For example, a central processing unit or the like of a controller may, at various times, operate as a component/module for displaying graphics on a screen, a component/module for writing data to a storage medium, a component/module for receiving user input, and a component/module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple components/modules, the example includes the possibility that the same hardware may implement more than one of the recited components/modules, either contemporaneously or at discrete times or timings. The implementation of multiple components/modules, whether using more components/modules, fewer components/modules, or the same number of components/modules as the number of components/modules, is merely an implementation choice and does not generally affect the operation of the components/modules themselves.

Accordingly, it should be understood that any recitation of multiple discrete components/modules in this disclosure includes implementations of those components/modules as any number of underlying components/modules, including, but not limited to, a single component/module that reconfigures itself over time to carry out the functions of multiple components/modules, and/or multiple components/modules that similarly reconfigure, and/or special purpose reconfigurable components/modules.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A direct current (DC) power electronics module comprising:
an electronics component configured to provide DC power to one or more of a first battery and a second battery;
a processor configured to communicate with the electronics component; and
non-transitory computer-readable media configured to store computer-executable instructions configured to cause the processor to:
determine one or more connections with the first battery and the second battery to the DC power electronics module; and
allocate DC power to one or more of the first battery and the second battery responsive to the determination that one or more of the first battery and the second battery are connected to the DC power electronics module.

2. The DC power electronics module of claim 1, wherein the instructions are further configured to cause the processor to sequentially allocate DC power to the first battery and the second battery.

3. The DC power electronics module of claim 1, wherein the instructions are further configured to cause the processor to allocate DC power to the first battery and the second battery responsive to a previously defined time interval.

4. The DC power electronics module of claim 1, further comprising a communication device configured to allow communications with the processor, wherein the instructions are further configured to cause the processor to:
receive via the communications device first use history information of a first device associated with the first battery; and
receive via the communications device second use history information of a second device associated with the second battery; and
allocate DC power responsive to the received first use history information and the received second use history information.

5. The DC power electronics module of claim 4, wherein:
the first use history information is received from the first device; and
the second use history information is received from the second device.

6. The DC power electronics module of claim 4, wherein the first use history information and the second use history information include information chosen from date of use information and time of use information.

7. The DC power electronics module of claim 4, wherein the first use history information and the second use history information include travel information.

8. A charging system comprising:
a connection device couplable to a first battery and a second battery; and
a direct current (DC) power electronics module including:
an electronics component configured to provide DC power to the first battery and the second battery via the connection device;
a processor configured to communicate with the electronics component; and
non-transitory computer-readable media configured to store computer-executable instructions configured to cause the processor to:
determine connection status of the first battery and the second battery to the connection device; and
allocate DC power to the first battery and the second battery responsive to the determination that the first battery and the second battery are connected to the connection device.

9. The charging system of claim 8, wherein the instructions are further configured to cause the processor to sequentially allocate DC power to the first battery and the second battery.

10. The charging system of claim 8, wherein the instructions are further configured to cause the processor to allocate DC power to the first battery and the second battery responsive to a previously defined time interval.

11. The charging system of claim 8, wherein:
the DC power electronics module further includes a communication device configured to allow communications with the processor; and
the instructions are further configured to cause the processor to:
receive via the communications device first use history information of a first device associated with the first battery; and
receive via the communications device second use history information of a second device associated with the second battery; and
allocate DC power responsive to the received first use history information and the received second use history information.

12. The charging system of claim 11, wherein:
the first use history information is received from the first device; and
the second use history information is received from the second device.

13. The charging system of claim 11, wherein the first use history information and the second use history information include information chosen from date of use information and time of use information.

14. The charging system of claim 11, wherein the first use history information and the second use history information include travel information.

15. A method comprising:
detecting battery connections to a direct current (DC) power electronics module; and
responsive to detecting a first battery and a second battery being connected to the DC power electronics module, allocating DC power to the first battery and the second battery.

16. The method of claim 15, wherein allocating DC power further includes sequentially allocating DC power to the first battery and the second battery.

17. The method of claim 15, wherein allocating DC power further includes allocating DC power to the first battery and the second battery at a previously defined time interval.

18. The method of claim 15, further comprising:
receiving first use history information from the first device; and
receiving second use history information from the second device; and
wherein allocating DC power further includes allocating DC power responsive to the received first use history information and the received second use history information.

19. The method of claim 18, wherein the first use history information and the second use history information include information selected from date of use information and time of use information.

20. The method of claim 18, wherein the first use history information and the second use history information include travel information.
